(19) United States
(12) Patent Application Publication
(10) Pub. No.: US 2014/0337408 A1
(43) Pub. Date: Nov. 13, 2014

(54) SYSTEMS, METHODS AND MEDIA FOR MINIMIZING DATA DOWNLOADS

(71) Applicant: AppSense Limited, Warrington (GB)

(72) Inventors: Antony Workman, Bolton (GB); Ian James McLean, Lymm (GB)

(21) Appl. No.: 13/892,137

(22) Filed: May 10, 2013

(51) Int. Cl. H04L 29/08; H04L 29/06

(52) U.S. Cl. CPC H04L 29/08549; H04L 29/06047
USPC 709/203

(57) ABSTRACT

Systems, methods and media are provided for minimizing data downloads. One method includes providing a virtual view of a list of files remotely stored in a cloud storage server. The method also includes detecting a user request for file data associated with a file selected from the virtual view and inspecting a local cache associated with the selected file to determine whether the requested file data already exists in the cache. The method further includes displaying the file data from the cache when it is determined that the cache already includes the file data. When it is determined that the cache does not include the file data, the method also includes generating a client request for the file data, sending it to the server, receiving the requested file data from the server, updating the cache using the file data received from the server; and displaying the requested file data.

### TECHNICAL FIELD

Disclosed systems, methods and media relate to sparse data downloads from a cloud storage server to a cloud storage client. Specifically, disclosed systems, methods and media relate to minimizing data downloads by minimizing the amount of data transferred from a cloud storage server to a cloud storage client device in connection with downloading one or more files, as well as the number of file/file-data requests made from the client device to the server.

### BACKGROUND

In today's online world, data is stored in a multitude of sources and regularly downloaded to various client end points. Minimizing the amount of data that is transferred from a data storage server to the end points is obviously of great importance. In a cloud storage system, for example, user data can be stored in one or more cloud storage servers and users can download the data from the storage servers using cloud storage client devices whenever the users need to access the data.

There are several existing technologies for minimizing the amount of data transferred from storage servers to client end points. Some of the existing technologies provide a client with a virtual view of remote files and files are downloaded only when they are requested by the client. With these technologies, however, an entire file must be downloaded even if the client needs to access only a part of the file. Other existing technologies utilize file-deltas to ensure that only the changes that are made to the already downloaded files are transferred. The file-delta technologies, however, still require downloading an entire file in order to access the file.

### SUMMARY

In accordance with the disclosed subject matter, systems, methods and media are provided for minimizing data downloads in a cloud storage system. Specifically, disclosed systems, methods and media provide for minimizing data downloads by minimizing the amount of data transferred from a cloud storage server to a cloud storage client device in connection with downloading one or more files, as well as the number of file/file-data requests made from the client device to the server. For example, the disclosed subject matter encompasses a method that includes providing, in a cloud storage directory in a cloud storage client, a virtual view of a list of files that are remotely stored in a cloud storage server. The method also includes detecting a user request for file data associated with a file selected from the virtual view and inspecting a local cache associated with the selected file to determine whether the requested file data already exists in the local cache. The method further includes displaying the requested file data from the local cache if it is determined that the local cache already includes the requested file data. If, however, it is determined that the local cache does not include the requested file data, the method also includes generating a client request for the file data, sending the client request to the cloud storage server, receiving the requested file data from the cloud storage server, updating the local cache using the requested file data received from the cloud storage server and displaying the requested file data.

In some embodiments, the method may further include determining whether a local cache exists for the selected file and creating a local cache for the selected file if it is determined that no local cache exists for the selected file. In some embodiments, the virtual view includes names of the files in the list. In some embodiments, the file data includes a set of representative metadata associated with the selected file and the representative metadata is displayed using a floating text box. In some embodiments, the selected file includes a document file and the file data includes data for a part of a document contained in the document file.

In some embodiments, the user request includes a request for opening the document file. In some embodiments, the user request includes navigation to a different part of the document. In some embodiments, generating the client request for the file data from the cloud storage server includes formulating a set of request parameters, including an offset and a length that describe the data for the at least a part of the document. In some embodiments, the client request for the file data is sent to, and the requested file data is received from, the cloud storage server through a secure web interface provided by the cloud storage server.

The disclosed subject matter also includes an apparatus that includes one or more interfaces configured to provide communication with one or more devices over a network and a processor in communication with the one or more interfaces. The processor is configured to run a download management module that is configured to provide, in a cloud storage directory in the apparatus, a virtual view of a list of files that are remotely stored in a cloud storage server. The download management module is also configured to detect a user request for file data associated with a file selected from the virtual view and inspect a local cache associated with the selected file to determine whether the requested file data already exists in the local cache. The download management module is further configured to display the requested file data from the local cache if it is determined that the local cache already includes the requested file data. If, however, it is determined that the local cache does not include the requested file data, the download management module is also configured to generate a client request for the file data, send the client request to the cloud storage server, receive the requested file data from the cloud storage server, update the local cache using the requested file data received from the cloud storage server and display the requested file data.

The disclosed subject matter further includes a non-transitory computer readable medium having executable instructions operable to cause an apparatus to provide, in a cloud storage directory, a virtual view of a list of files that are remotely stored in a cloud storage server. The executable instructions are also operable to cause the apparatus to detect a user request for file data associated with a file selected from the virtual view and inspect a local cache associated with the selected file to determine whether the requested file data already exists in the local cache. The executable instructions are further operable to cause the apparatus to display the requested file data from the local cache if it is determined that the local cache already includes the requested file data. If, however, it is determined that the local cache does not include the requested file data, the executable instructions are also operable to cause the apparatus to generate a client request for the file data, send the client request to the cloud storage server, receive the requested file data from the cloud storage server, update the local cache using the requested file data received from the cloud storage server and display the requested file data.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 is a flow diagram for minimizing data downloads in accordance with an embodiment of the disclosed subject matter.

FIG. 3 is a block diagram of a cloud storage client device in accordance with an embodiment of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods and media that are within the scope of the disclosed subject matter.

The disclosed systems, methods and media are provided for minimizing data downloads from a cloud storage server by minimizing the amount of data transferred from the cloud storage server to a cloud storage client device in connection with downloading one or more files, as well as the number of file/file-data requests made from the cloud storage client device to the cloud storage server. In one embodiment, for example, a user of a cloud storage client device navigates to a cloud storage directory in the cloud storage client device to download a document file. In some embodiments, a cloud storage client device is a computing device on which a cloud storage client software program (“cloud storage program”) runs and a cloud storage directory is a file directory that is managed by the cloud storage program. A cloud storage program may be a background daemon process for monitoring user interactions with a virtual view of files remotely located in a cloud storage server and providing responses to user requests for file data.

The user looks through a virtual view of a list of files shown in the cloud storage directory that are stored in a cloud storage server, looking for the document file. In some embodiments, the files are stored in the user's file storage folder located in the cloud storage server. In some embodiments, the file storage folder located in the cloud storage server provides a mirror image of the cloud storage directory in the cloud storage client device. The user locates a file that she suspects is the document file that she wants to download. She selects the located file by, for example, placing a mouse cursor over the located file. In some embodiments, the user can select the located file by clicking a button on a mouse attached to the client device after placing the mouse cursor over the selected file.

The cloud storage program detects that the user selected the file name and checks a local cache associated with the selected file to determine whether the local cache includes a set of representative metadata for the located file. If it is determined that the local cache indeed includes the representative metadata, the metadata in the local cache is displayed to the user. In some embodiments, the metadata is stored at the start or end of the file. In some embodiments, the metadata is displayed in a floating text box that appears near the file name. The metadata may also be displayed using any other appropriate graphical user interface component. If it is determined, however, that the local cache does not include the representative metadata, the cloud storage program sends a request for the representative metadata of the located file to the cloud storage server. When the cloud storage program receives the representative metadata associated with the located file from the cloud storage server, the cloud storage program updates the local cache using the representative metadata for the file and displays the received metadata, e.g., in a floating text box. In some embodiments, the representative metadata of a file includes the file type (e.g., MS-Word document) and the number of pages, or slides, of a document in the file.

Based on the displayed representative metadata and/or the file name, the user further suspects that the located file may be the document file that she wants to download. In order to ascertain that the located file is indeed the document file that she wants to download, the user selects an option of showing a thumbnail image of the located file. The cloud storage program detects the user selection and checks the local cache associated with the located file to determine whether the local cache includes a portion of the located file that is required for generating a thumbnail image. If the local cache includes the required portion, the cloud storage program uses the required portion in the local cache to generate the requested thumbnail image. If the cache does not include the required portion, however, the cloud storage program sends a request to the cloud storage server for the required portion of the located file. The cloud storage program generates the requested thumbnail image when it receives the requested portion of the located file. Upon inspecting the displayed thumbnail image of the located file, the user confirms that the located file is indeed the document file that she wants to download.

The user opens the located document file and scrolls down to the second page of the document. The cloud storage program detects the scrolling and determines whether the local cache associated with the document file includes data for the second page of the document file. If the local cache includes the data, the cloud storage program uses the data in the cache to display the second page of the document. If the cache does not include the required content, the cloud storage program sends a request to the cloud storage server for the required data. The cloud storage program displays the second page of the document when it receives the data for the second page from the cloud storage server. The user modifies the second page by adding a sentence at the bottom of the second page and closes the document file. The cloud storage program detects the modification, updates the local cache associated with the document file in accordance with the modification and uploads only the modified portion of the document file to the cloud storage server.

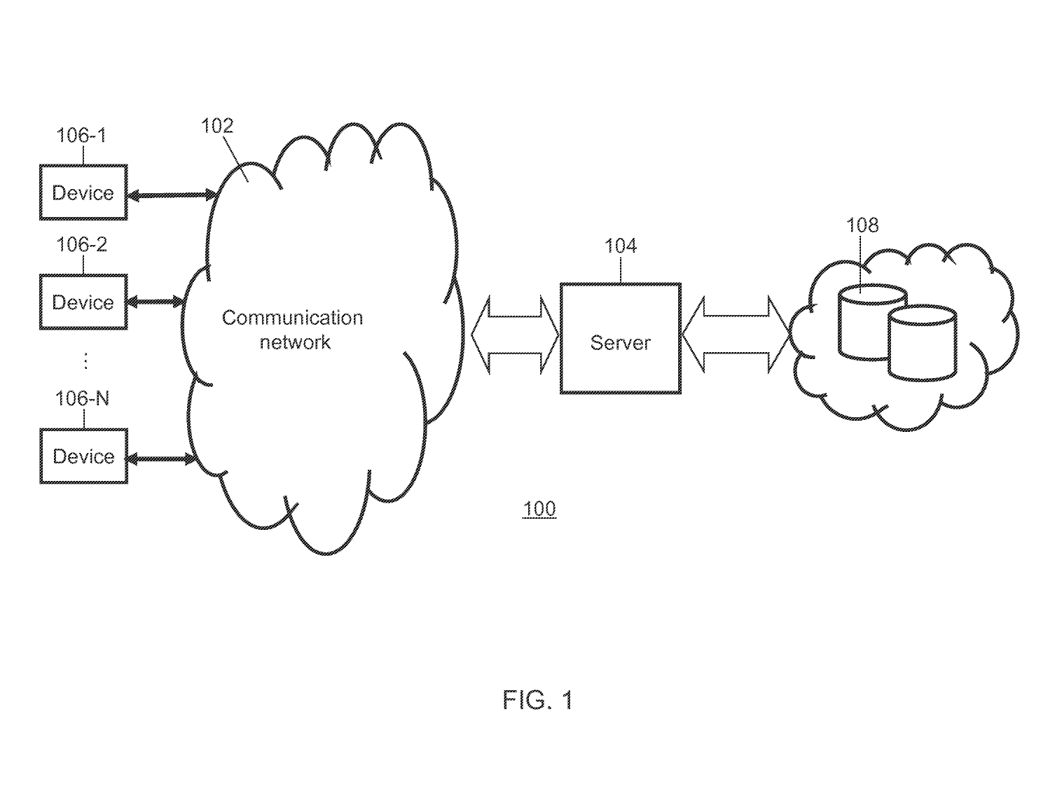

FIG. 1 illustrates a diagram of a networked communication arrangement 100 in accordance with an embodiment of the disclosed subject matter. The networked communication arrangement 100 can include a communication network 102, a cloud storage server 104, at least one cloud storage client device 106 (e.g., cloud storage client devices 106-1, 106-2, . . . 106-N), and a database 108.

Each cloud storage client device 106 can send data to, and receive data from, the cloud storage server 104 over the communication network 102. In some embodiments, a cloud storage client device 106 may be any computing device that runs a cloud storage client software program (also referred to as “cloud storage application program”). Each cloud storage client device 106 can be directly coupled to the cloud storage server 104; alternatively, each cloud storage client device 106 can be connected to the cloud storage server 104 via any other suitable device(s), communication network(s), or combination thereof. For example, each cloud storage client device 106 can be coupled to the cloud storage server 104 via one or more routers, switches, access points, and/or communication networks (as described below in connection with communication network 102). A cloud storage client device 106 can include a desktop computer, a mobile computer, a tablet computer, a cellular device, a smartphone or any computing system that is capable of performing computation. The cloud storage server 104 can be a single server, or a network of servers, or a farm of servers in a data center.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the network 102 as a single network; however, the network 102 can include multiple interconnected networks listed above.

The cloud storage server 104 can be coupled to a database system. The database 108 can include at least one of two types of databases: a local database and a remotely located database. The database 108 can include any data supported by one or more data structures; alternatively, it could include one or more database management system (DBMS) or a distributed database. The database 108 can also include at least one of a relational database, object database (a.k.a., object-oriented database), XML database, cloud database, active database, and a data warehouse. In some embodiments, the database 108 may be a file server or other types of file storage. The database 108 may include at least one physical, non-transitory storage medium.

In some embodiments, the database 108 can be provided as an enterprise system in a corporate environment For example, the communication network 102, the cloud storage server 104, the cloud storage client devices 106, and the database 108 can be located in close proximity and can be a part of a single company. In some cases, the cloud storage server 104, the cloud storage client devices 106, and the database 108 can be located in the same building and can be coupled to one another via a local communication network. The local communication network can include a local area network (LAN), a corporate network, and a virtual private network (VPN) associated with the corporate network. FIG. 1 shows the database 108 as separate from the communication network 102. However, the database 108 can be part of communication network 102 or another communication network.

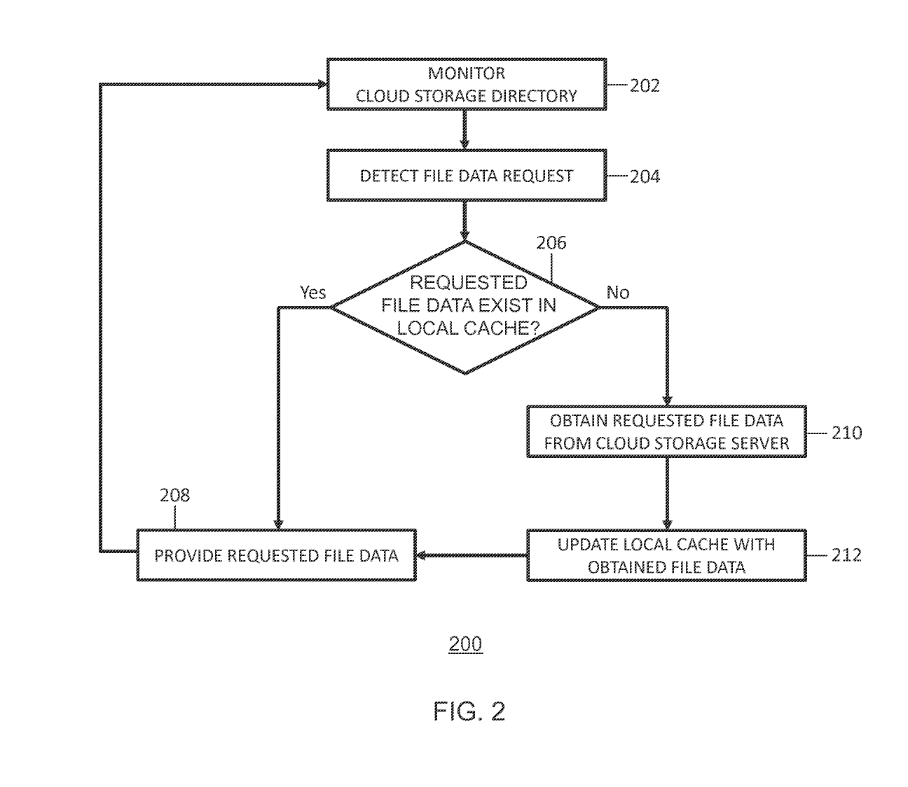

FIG. 2 is a flow diagram 200 or minimizing data downloads in accordance with an embodiment of the disclosed subject matter. At 202, a cloud storage directory located in a cloud storage client device (e.g., cloud storage client device 106) is monitored. In some embodiments, the cloud storage directory provides a virtual view of a list of files that are remotely stored in a cloud storage server (e.g., cloud storage server 104). For example, a cloud storage client software program (cloud storage program) running in a cloud storage client device, such as a cloud storage application, can display in a cloud storage directory in the cloud storage client device a list of names of files that are remotely stored in a cloud storage server. In some embodiments, a cloud storage program is configured to monitor for user requests related to the remote files displayed in the cloud storage directory. In some embodiments, the cloud storage client software program is a background process, or a daemon, that runs in the background of a cloud storage client device for monitoring user requests related to the displayed remote files.

At 204, file data request made by a user of a cloud storage client device (e.g., cloud storage client device 106) is detected. For example, the cloud storage client software program (“cloud storage program”) may be configured to detect user requests for file data that are associated with one or more of the remote files stored in a cloud storage server (e.g., cloud storage server 104). In some embodiment, a user makes a request for file data through a user interface of a user application running in the cloud storage client device that interact with a cloud storage program.

File data may include metadata associated with a file, such as a file type (e.g., text file, graphics file, movie clip) and the number of pages, or slides, of a document in the file. For instance, a user of a cloud storage client device (e.g., her laptop computer) may look through a virtual view of a list of remote files (e.g., a list of names of files remotely stored in a cloud storage server) that is displayed on a cloud storage directory in the client device to identify a document file that she worked on a few weeks ago. The user may select a file that she suspects may be the document file that she is looking for using a mouse attached to her laptop and click a mouse button to view a set of representative metadata (e.g., date/time the file was last modified) of the selected file. The cloud storage program can be configured to detect the selection of the file and the mouse click by the user and recognize the user actions as a request for representative metadata of the selected file.

File data may also include any amount (e.g., bits, bytes, blocks, etc.) of data associated with a file. For example, file data may include all the data that are necessary to display particular page(s) of a document file or an image file. Referring back to the laptop user example, for instance, the user confirms that the selected file is indeed the document file that she was looking for based on the metadata and opens the file, e.g., by double-clicking a mouse button after selecting the file. The cloud storage program can be configured to detect the user action (e.g., double-clicking mouse button) for opening the file and recognize it as a request for file data associated with the first few pages of the document contained in the file. In some embodiments, the cloud storage program is configured to recognize a user's action for opening a document file as a request for file data associated with only the first page of the document in the document file. Once the document file is open, as the user begins navigating to different part(s) of the document, the cloud storage program can further detect the navigation action by the user and recognize it as a request for file data that corresponds to the different part(s) of the document.

At 206, the cloud storage program determines whether the requested file data exists in a local cache in a cloud storage client device (e.g., cloud storage client device 106). In some embodiments, a local cache is created in a cloud storage client device for each file for which data has been downloaded. In some embodiments, a local cache is created in the cloud storage client device for a file when data associated with the file is downloaded from a cloud storage server (e.g., cloud storage server 104) for the first time. In some embodiments, a local cache for a file in a cloud storage client device is updated each time file data related to the file is downloaded from a cloud storage server.

Referring back to the laptop user example, for instance, when the user's action for requesting representative metadata of a document file is detected by the cloud storage program, the cloud storage program first checks a local cache associated with the document file in the user's laptop to determine whether the local cache for the document file already includes the representative metadata. When the user's action for opening the document file is detected by the cloud storage program, the cloud storage program checks the local cache to determine whether the local cache already includes data for, e.g., the first few pages of the document contained in the document file.

If the cloud storage program determines at 206 that the local cache in the cloud storage client device already includes the requested file data, the cloud storage program provides at 208 the requested file data stored in the local cache for displaying it on the cloud storage client device. In some embodiments, the cloud storage program returns the requested file data to a user application, which requested the file data, for displaying the file data for a user. Referring back to the laptop user example, for instance, if the cloud storage program determines that the local cache for the document file already includes the requested representative metadata, or the requested data for the first few pages, of the document, the cloud storage program provides the representative metadata, or the requested data for the first few pages of the document, for displaying it on the user's laptop.

If, however, the cloud storage program determines at 206 that the local cache does not already include the requested file data, the cloud storage program obtains at 210 the requested file data from the cloud storage server. The cloud storage program can, for example, generate a request for the requested file data, establish a communication with the cloud storage server, send the generated file data request and receive a response including the requested file data from the cloud storage server.

Referring to the laptop user example, for instance, if the cloud storage program running in the user's laptop determines that the local cache does not include the requested metadata, or the data for the first few pages, of the document in the document file, the cloud storage program generates a request for the metadata, or the data for the first few pages, of the document file and send the request to a cloud storage server. The cloud storage program can, for example, generate the request by formulating request attributes/parameters, such as a set of predefined number/types of metadata or an offset and a length that describe the data for the first few pages of the document, to be included in the request. The cloud storage program can also maintain a (secure) communication session with the cloud storage server and download the requested file data from the cloud storage server when the cloud storage server provides the requested file data in response to the request.

At 212, the cloud storage program updates the local cache associated with the document file using the requested file data that is received from the cloud storage server. Referring back to the laptop user example, for instance, the cloud storage program can update the local cache associated with the document file using the representative metadata, or the data for the first few pages of the document, such that the same file data can be provided locally when they are requested again from the user's laptop in the future.

Once the local cache for the document file is updated using the requested file data obtained from the cloud storage server, the cloud storage program provides at 208 the requested file data obtained from the cloud storage server for displaying it on the cloud storage client device for the user.

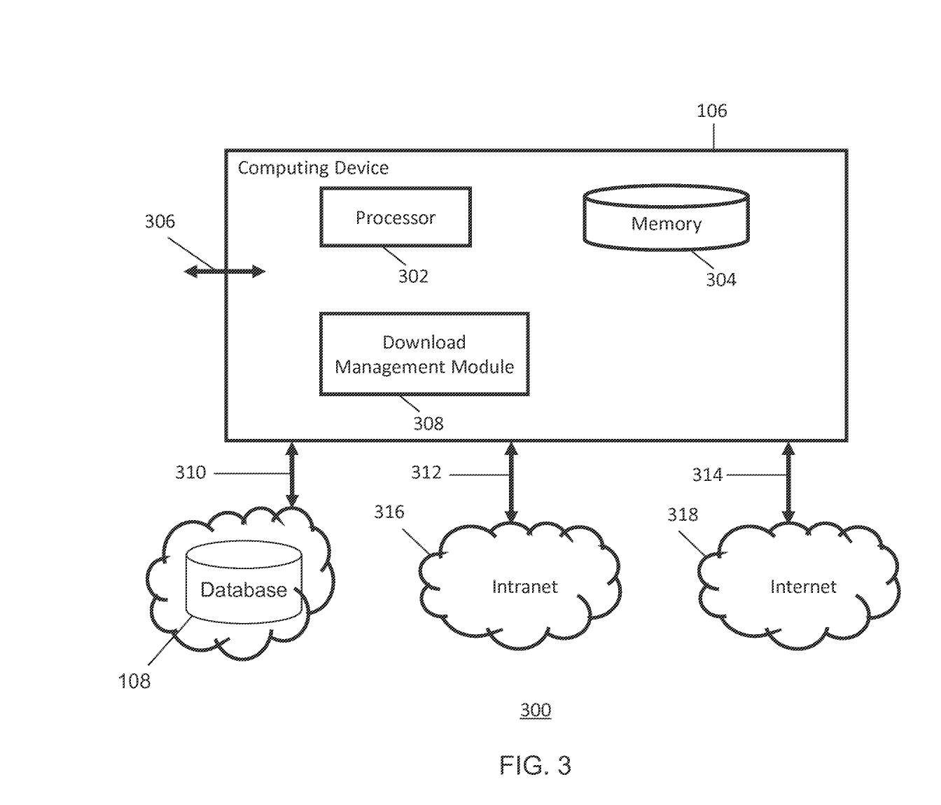

FIG. 3 is a block diagram 300 of the cloud storage client device 106 in accordance with certain embodiments of the disclosed subject matter. The block diagram 300 shows a cloud storage client device 106, which includes a processor 302, a memory 304, interfaces 306, 310, 312, and 314, and a download management module 308 Block diagram 300 also shows the cloud storage client device 106 communicatively coupled to a database 108, an Intranet 316, and the Internet 318. The memory 304 and the interfaces 306, 310, 312, and 314 are communicatively coupled to the processor 302. The cloud storage client device 106 can communicate with the cloud storage server 104 (not shown) via the interface 306; the cloud storage client device 106 can communicate with the database 108 via the interface 310; the cloud storage client device 106 can communicate with the Intranet 316 via the interface 312; and the cloud storage client device 106 can communicate with the Internet 318 via the interface 314. The interfaces 306, 310, 312, and 314 are shown as separate interfaces but may be the same physical interface. The processor 302 can run software programs and modules, including the download management module 308. The memory 304 is capable of storing data that can be used by the processor 302 to run the software programs and modules, including the download management module 308.

The download management module 308 can be configured to communicate, or interact, with server 104 through the interface 306 for providing, in a cloud storage directory in the cloud storage client device 106, a virtual view of a list of files that are remotely stored in the cloud storage server 104 (not shown). The download management module 308 can be also configured for detecting a user request for file data associated with a file selected from the virtual view and inspecting a local cache associated with the selected file to determine whether the requested file data already exists in the local cache. The download management module 308 can be further configured for displaying the requested file data from the local cache if it is determined that the local cache already includes the requested file data.

If, however, it is determined that the local cache does not include the requested file data, the download management module 308 can be also configured for generating a client request for the file data, sending the client request to the cloud storage server and receiving the requested file data from the cloud storage server. The download management module 308 can be further configured for updating the local cache using the requested file data received from the cloud storage server and displaying the received file data.

In some embodiments, the virtual view includes a representative characteristic of each file in the list. In some embodiments, the file data includes a set of representative metadata associated with the selected file. In some embodiments, the selected file includes an image file and the file data includes data for at least a part of images contained in the image file. In some embodiments, the user request includes a request for opening the document file. In some embodiments, the user request includes navigation to a different part of the image file.

FIG. 3 shows a cloud storage client device 106 having the download management module 308 that performs the above-described operations in accordance with certain embodiments of the disclosed subject matter. The cloud storage client device 106 may include additional modules, fewer modules, or any other suitable combination of modules that perform any suitable operation or combination of operations.

The interfaces 306, 310, 312, and 314 provide an input and/or output mechanism to communicate over a network. The interfaces 306, 310, 312, and 314 enable the cloud storage client device 106 to communicate with the cloud storage server 104 (not shown), as well as other network nodes in the communication network 102. The interfaces 306, 310, 312, and 314 can be implemented in hardware to send and receive signals in a variety of mediums, such as optical, copper, and wireless, and in a number of different protocols some of which may be non-transient.

The cloud storage client device 106 can include user equipment (also referred to as mobile device, mobile terminal, etc.). The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the user equipment, in which case the screen can be used instead of the full keyboard. The user equipment can also keep global positioning coordinates, profile information, or other location information.

The cloud storage client device 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The cloud storage client device 106 may be configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The cloud storage client device 106 can also provide a variety of user interfaces such as a keyboard, a touch screen, a trackball, a touch pad, and/or a mouse. The cloud storage client device 106 may also include speakers and a display device in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, systems and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
providing, in a cloud storage directory in a cloud storage client, a virtual view of a list of files that are remotely stored in a cloud storage server;
detecting a user request for file data associated with a file selected from the virtual view;
inspecting a local cache associated with the selected file to determine whether the requested file data already exists in the local cache;
displaying the requested file data from the local cache when it is determined that the local cache already includes the requested file data; and
when it is determined that the local cache does not include the requested file data:
generating and sending a client request for the file data to the cloud storage server,
receiving the requested file data from the cloud storage server,
updating the local cache using the requested file data received from the cloud storage server, and
displaying the requested file data.

2. The method of claim 1, further comprising:
determining whether the local cache exists for the selected file; and
creating the local cache for the selected file when it is determined that no local cache exists for the selected file.

3. The method of claim 1, wherein the virtual view includes names of the files in the list.

4. The method of claim 1, wherein the file data includes a set of representative metadata associated with the selected file.

5. The method of claim 4, wherein the representative metadata is displayed using a floating text box.

6. The method of claim 1, wherein the selected file includes a document file and the file data includes data for a part of a document contained in the document file.

7. The method of claim 6, wherein the user request includes a request for opening the document file.

8. The method of claim 6, wherein the user request includes navigation to a different part of the document.

9. The method of claim 6, wherein generating the client request for the file data from the cloud storage server includes formulating a set of request parameters, including an offset and a length that describe the data for a part of the document.

10. The method of claim 1, wherein the client request for the file data is sent to, and the requested file data is received from, the cloud storage server through a secure web interface provided by the cloud storage server.

11. An apparatus comprising:
one or more interfaces configured to provide communication with one or more devices over a network; and
a processor, in communication with the one or more interfaces, configured to run download management module stored in memory that is configured to:
provide, in a cloud storage directory in the apparatus, a virtual view of a list of files that are remotely stored in a cloud storage server;
detect a user request for file data associated with a file selected from the virtual view;
inspect a local cache associated with the selected file to determine whether the requested file data already exists in the local cache;
display the requested file data from the local cache when it is determined that the local cache already includes the requested file data; and
when it is determined that the local cache does not include the requested file data:
generate and send a client request for the file data to the cloud storage server,
receive the requested file data from the cloud storage server,
update the local cache using the requested file data received from the cloud storage server, and
display the requested file data.

12. The apparatus of claim 11, wherein the virtual view includes a representative characteristic of each file in the list.

13. The apparatus of claim 11, wherein the file data includes a set of representative metadata associated with the selected file.

14. The apparatus of claim 11, wherein the selected file includes an image file and the file data includes data for at least a part of images contained in the image file.

15. The apparatus of claim 14, wherein the user request includes a request for opening the document file.

16. The apparatus of claim 14, wherein the user request includes navigation to a different part of the image file.

17. A non-transitory computer readable medium having executable instructions operable to cause an apparatus to:
provide, in a cloud storage directory in the apparatus, a virtual view of a list of files that are remotely stored in a cloud storage server;
detect a user request for file data associated with a file selected from the virtual view;
inspect a local cache associated with the selected file to determine whether the requested file data already exists in the local cache;
display the requested file data from the local cache when it is determined that the local cache already includes the requested file data; and
when it is determined that the local cache does not include the requested file data:
generate and send a client request for the file data and to the cloud storage server,
receive the requested file data from the cloud storage server,
update the local cache using the requested file data received from the cloud storage server, and
display the requested file data.

18. The computer readable medium of claim 17, wherein the executable instructions are further operable to cause the apparatus to:
determine whether the local cache exists for the selected file; and
create the local cache for the selected file when it is determined that no local cache exists for the selected file.

19. The computer readable medium of claim 17, wherein generating the client request for the file data from the cloud storage server includes formulating a set of request parameters, including an offset and a length that describe the data for a part of the document.

20. The computer readable medium of claim 17, wherein the client request for the file data is sent to, and the requested file data is received from, the cloud storage server through a secure web interface provided by the cloud storage server.
